(19) United States
(12) Patent Application Publication
(10) Pub. No.: US 2006/0035057 A1
(43) Pub. Date: Feb. 16, 2006

(54) Heat-coupling mechanism and method for combining members with same

(75) Inventor: Hsi-Yu Chen, Taipei (TW)

Correspondence Address: MADSON & METCALF;GATEWAY TOWER WEST, SUITE 900, 15 WEST SOUTH TEMPLE, SALT LAKE CITY, UT, 84101, US

(73) Assignee: Primax Electronics Ltd.

(21) Appl. No.: 11/129,725

(22) Filed: May 13, 2005

(30) Foreign Application Priority Data
Aug. 12, 2004 (TW) 093124214

(51) Int. Cl. B32B 7/00

(52) U.S. Cl. 428/119

(57) ABSTRACT

A heat-coupling mechanism for coupling a first member to a second member by heating includes a base protruding from the first member; and a thermoplastic post extending from the base to penetrate through a through hole of the second member and deformable with heat to extensively overlie the second member beyond the through hole so as to stop the base from escaping from the through hole. The base has a hollow space. The first and second members can be separated by cutting off the portion of the thermoplastic post overlying the second member. Meanwhile, the hollow space will be exposed. If necessary, a screw or bolt can be inserted into the hollow space through the through hole to couple the first and second members together again.

### FIELD OF THE INVENTION

The present invention relates to a coupling mechanism and a coupling method for securing one member to another, and more particularly to a heat-coupling mechanism and a heat-coupling method for securing one member to another.

### BACKGROUND OF THE INVENTION

Connecting elements such as screws, bolts, pins are commonly used to combine two or more separate members together. Since these elements are cheap, reusable and easy-operated, they are popular in a variety of applications. One of the examples is to couple a key frame to a printed circuit board, as shown in FIGS. 1(a)˜(c). In order to clearly illustrate the combination of the key frame 10 with the printed circuit board 20 via the screw means 22 used in the prior art, the elements in these figures are shown upside down. As shown, each key K of the key frame 10 corresponds to a contact switch S of the printed circuit board 20. When the screw means 22 that generally includes more than ten screws or bolts penetrates through the through holes 21 of the printed circuit board 20 and enters the recess 12 in a protrusion 11 of the key frame 10, the key frame 10 and the printed circuit board 20 can be screwed together with the keys K aligned with respective contact switches S. Accordingly, the keys K can be pushed down to activate corresponding contact switches. An enlarged resolving diagram of the portion A of FIG. 1(b) is shown in FIG. 1(c) for further illustrating the coupling mechanism of the prior art.

In spite it is convenient to use screwing means to combine members together, it is troublesome when the members need to be separated first and then assembled again for some reasons. For example, when the printed circuit board 20 and the key frame 10 have to be separated for maintenance or changing parts, all the tens of screws or bolts have to be detached from the assembly. Afterwards, those screws or bolts are inserted into the through holes and recesses again for coupling the members together. In other words, there will be three screwing operations for completing the maintenance or changing parts, including originally assembling, separating for check and then re-assembling.

### SUMMARY OF THE INVENTION

Therefore, the present invention provides a heat-coupling mechanism and method that involves in easy coupling operation.

The present invention relates to a heat-coupling mechanism for coupling a first member to a second member by heating, which comprises a base protruding from the first member; and a thermoplastic post extending from the base to penetrate through a through hole of the second member and deformable with heat to extensively overlie the second member beyond the through hole so as not to escape from the through hole.

Preferably, the base has a hollow space therein for optionally receiving a coupling member.

Preferably, a diameter of the through hole is substantially equal to that of the hollow space and slightly greater than that of the coupling member.

For example, the coupling member is a screw or a bolt.

In an embodiment, the base has a diameter greater than that of the through hole and the thermoplastic post has a diameter less than that of the through hole so that the base sustains against the second member to keep the first and second members a certain distance away from each other after the thermoplastic post penetrates through the through hole.

In an embodiment, the base is integrally formed with the first member.

In an embodiment, the thermoplastic post is integrally formed with the base.

For example, the thermoplastic post is formed of engineering plastics, e.g. acrylonitrile butadiene styrene (ABS), polycarbonate (PC) or a mixture thereof.

The heat-coupling mechanism, for example, can be used for coupling a key frame of a keyboard device to a printed circuit board of the keyboard device.

The present invention also relates to a method for coupling a first member to a second member, wherein the first member having a hollow protrudent thermoplastic portion, and the second member having a through hole. The method comprises steps of penetrating the hollow protrudent thermoplastic portion through the through hole; and heating a free end of the hollow protrudent thermoplastic portion exposed from the through hole until the free end of the hollow protrudent thermoplastic portion is deformed to extensively overlie the second member beyond the through hole, thereby stopping the hollow protrudent thermoplastic portion escaping from the through hole.

For some application, the first and second members need be separated temporarily. In this case, the present method further comprises steps of removing the free end of the hollow protrudent thermoplastic portion overlying the second member so as to expose a hollow space of the hollow protrudent thermoplastic portion, and then inserting a coupling member into the hollow space through the through hole to couple the first and second members together again.

In an embodiment, the method further comprises a step of keeping the first member a certain distance away from the second member after the hollow protrudent thermoplastic portion penetrates through the through hole.

In an embodiment, the hollow protrudent thermoplastic portion includes a base having a diameter greater than that of the through hole and a thermoplastic post having a diameter less than that of the through hole so that the base sustains against the second member to keep the first and second members the certain distance away from each other after the thermoplastic post penetrates through the through hole.

### BRIEF DESCRIPTION OF THE DRAWINGS

The above objects and advantages of the present invention will become more readily apparent to those ordinarily skilled in the art after reviewing the following detailed description and accompanying drawings, in which:

FIGS. 1(a) and 1(b) are schematic cross-sectional diagrams showing steps of assembling a keyboard according to prior art;

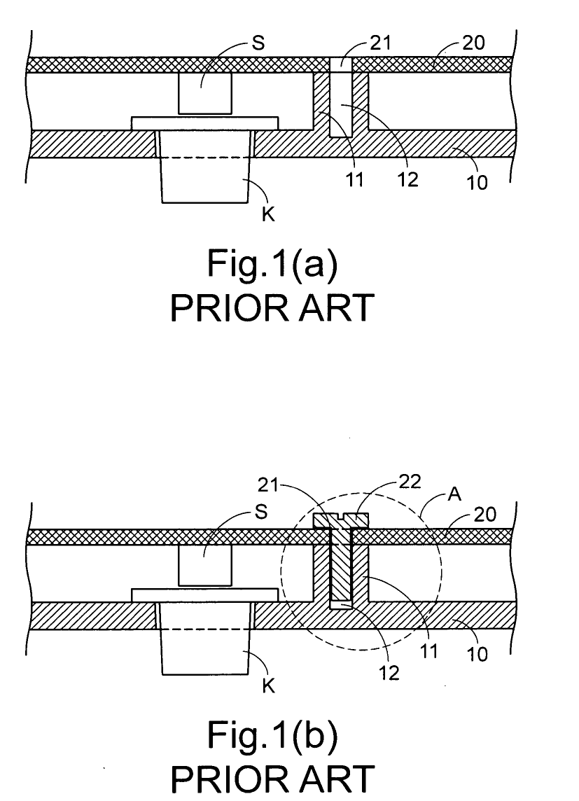

FIG. 1(c) is a partially enlarged perspective view of the portion A of FIG. 1(b);

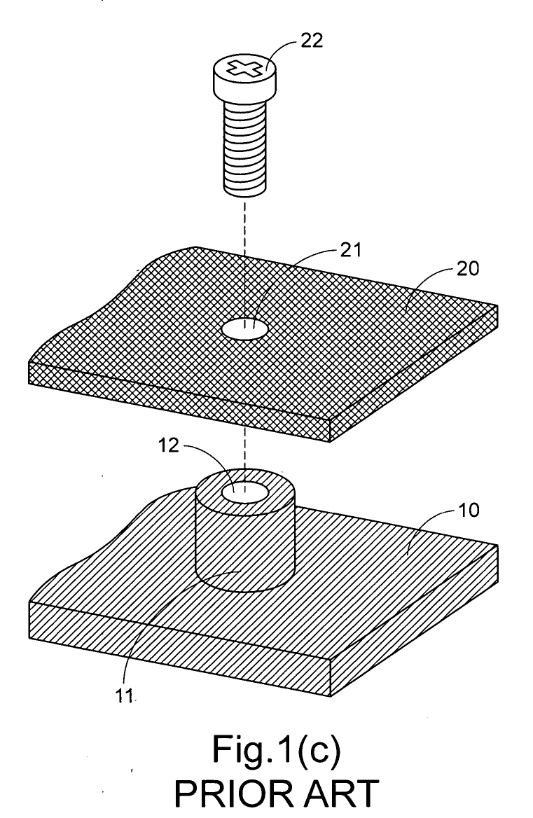

FIGS. 2(a) and 2(b) are schematic cross-sectional diagrams showing steps of assembling a keyboard according to an embodiment of the present invention; and

FIGS. 3(a) and 3(b) are schematic cross-sectional diagrams showing steps of reassembling the keyboard of FIG. 2 after the key frame and the printed circuit board are temporarily separated.

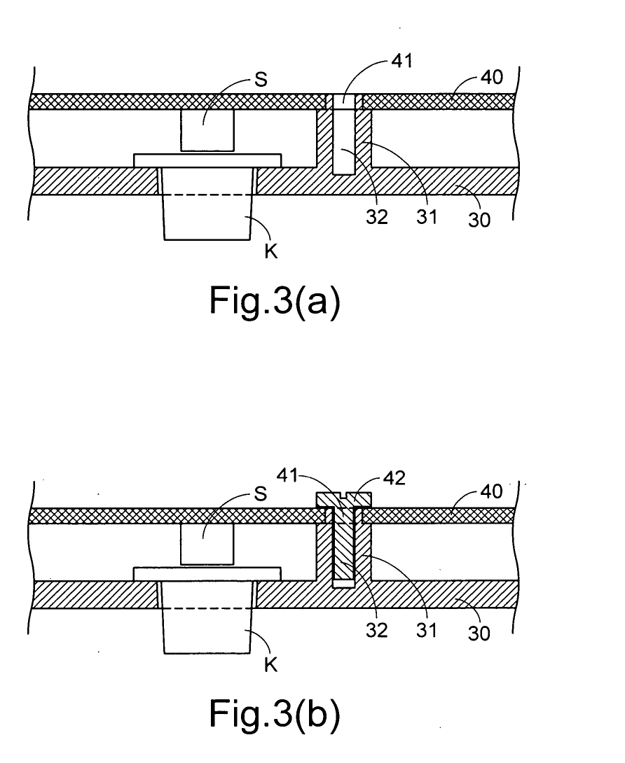

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

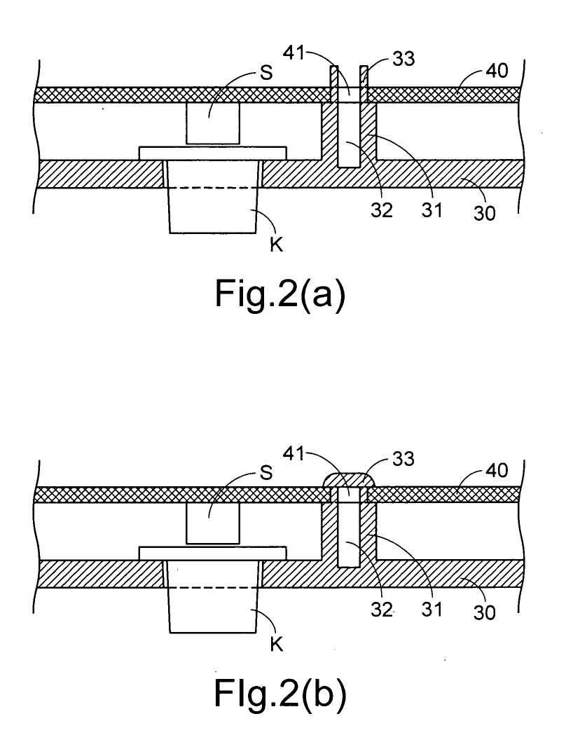

Please refer to FIGS. 2(a) and 2(b) which illustrate an embodiment of the coupling mechanism according to the present invention for coupling a key frame 30 to a printed circuit board 40. In order to clearly illustrate the combination of the key frame 30 with the printed circuit board 40 via the present coupling mechanism, the elements in these figures are shown upside down. As shown, each key K mounted in the key frame 30 corresponds to and is aligned with a contact switch S disposed on the printed circuit board 40. Accordingly, the key K can be pushed down to activate the corresponding contact switch S.

In this embodiment, the key frame 30 has a hollow protrudent portion including a base 31 and a free-end thermoplastic post 33, which are both hollow cylinder-shaped. The printed circuit board 40 has a through hole 41. The outer diameter of the base 31 is greater than that of the through hole 41 and the outer diameter of the thermoplastic post 33 is less than that of the through hole 41 so that the base 31 sustains against the lower surface of the printed circuit board 40 to keep the printed circuit board 40 and the main part of the key frame 30 a certain distance away from each other after the thermoplastic post 33 penetrates through the through hole 41.

The thermoplastic post 33 can be separately or integrally formed with the base 31 and the main part of the key frame 30. The material for forming the thermoplastic post 33 is preferably satisfactory in hardness, tenacity, rigidity and workability and has a low melting point. Therefore, after the thermoplastic post 33 penetrates through the through hole 41, the end part of the thermoplastic post 33 exposed from the through hole 41 can be softened and deformed with heat. When it is cooled, the end part will extensively overlie the printed circuit board 40 beyond the through hole 41, as shown in FIG. 2(b) so as to stop the protrudent portion of the key frame 30 from escaping from the through hole 41. In this way, the key frame 30 and the printed circuit board 40 can be secured together. A suitable material for forming the thermoplastic post 33 is, for example, engineering plastics, e.g. acrylonitrile butadiene styrene (ABS), polycarbonate (PC) or a mixture thereof. As known, ABS material has a melting point at 80˜100° C., and PC material has a melting point at 120˜130° C., which is suitable for the present application.

In this embodiment, the base 31 has a hollow space 32 with a threaded inner wall. For some reason such as maintenance or changing parts, the key frame 30 and the printed circuit board 40 need be separated temporarily. In this case, the thermoplastic portion 33 overlying the printed circuit board 40 is cut off or curetted off so as to allow the hollow protrudent portion to detach from the through hole 41. Meanwhile, the hollow space 32 will be exposed. When the key frame 30 and the printed circuit board 40 need be combined again, a screw can be screwed into the threaded hollow space 32 through the through hole 41. A bolt or any other suitable coupling member can also be used to combine the previously separated key frame 30 and printed circuit board 40.

According to the present invention, it is not necessary to insert or remove tens of screws or bolts to combine/detach the printed circuit board 40 with/from the key frame 30 any more. On the contrary, the tens of coupling operations can be easily performed by heating and the tens of decoupling operations can be easily performed by removing the overlying thermoplastic portions 33. Therefore, it is efficient and labor-saving.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A heat-coupling mechanism for coupling a first member to a second member by heating, comprising:
a base protruding from said first member; and
a thermoplastic post extending from said base to penetrate through a through hole of said second member and deformable with heat to extensively overlie said second member beyond said through hole so as not to escape from said through hole.

2. The heat-coupling mechanism according to claim 1 wherein said base has a hollow space therein for optionally receiving a coupling member.

3. The heat-coupling mechanism according to claim 3 wherein a diameter of said through hole is substantially equal to that of said hollow space and slightly greater than that of said coupling member.

4. The heat-coupling mechanism according to claim 3 wherein said coupling member is a screw or a bolt.

5. The heat-coupling mechanism according to claim 1 wherein said base has a diameter greater than that of said through hole and said thermoplastic post has a diameter less than that of said through hole so that said base sustains against said second member to keep said first and second members a certain distance away from each other after said thermoplastic post penetrates through said through hole.

6. The heat-coupling mechanism according to claim 1 wherein said base is integrally formed with said first member.

7. The heat-coupling mechanism according to claim 1 wherein said thermoplastic post is integrally formed with said base.

8. The heat-coupling mechanism according to claim 1 wherein said thermoplastic post is formed of engineering plastics.

9. The heat-coupling mechanism according to claim 1 wherein said thermoplastic post is formed of acrylonitrile butadiene styrene (ABS), polycarbonate (PC) or a mixture thereof.

10. The heat-coupling mechanism according to claim 1 wherein said first member is a key frame of a keyboard device and said second member is a printed circuit board of said keyboard device.

11. A method for coupling a first member to a second member, said first member having a hollow protrudent thermoplastic portion, said second member having a through hole, and said method comprising steps of:
penetrating said hollow protrudent thermoplastic portion through said through hole; and
heating a free end of said hollow protrudent thermoplastic portion exposed from said through hole until said free end of said hollow protrudent thermoplastic portion is deformed to extensively overlie said second member beyond said through hole, thereby stopping said hollow protrudent thermoplastic portion escaping from said through hole.

12. The method according to claim 11 further comprising a step of inserting a coupling member into a hollow space of said hollow protrudent thermoplastic portion through said through hole if said free end of said hollow protrudent thermoplastic portion overlying said second member is removed to expose said hollow space.

13. The heat-coupling mechanism according to claim 12 wherein said coupling member is a screw or a bolt.

14. The method according to claim 11 further comprising a step of keeping said first member a certain distance away from said second member after said hollow protrudent thermoplastic portion penetrates through said through hole.

15. The method according to claim 14 wherein said hollow protrudent thermoplastic portion includes a base having a diameter greater than that of said through hole and a thermoplastic post having a diameter less than that of said through hole so that said base sustains against said second member to keep said first and second members said certain distance away from each other after said thermoplastic post penetrates through said through hole.

16. The heat-coupling mechanism according to claim 15 wherein said base is integrally formed with said first member.

17. The heat-coupling mechanism according to claim 15 wherein said thermoplastic post is integrally formed with said base.

18. The heat-coupling mechanism according to claim 15 wherein said thermoplastic post is formed of engineering plastics.

19. The heat-coupling mechanism according to claim 15 wherein said thermoplastic post is formed of acrylonitrile butadiene styrene (ABS), polycarbonate (PC) or a mixture thereof.

20. The heat-coupling mechanism according to claim 11 wherein said first member is a key frame of a keyboard device and said second member is a printed circuit board of said keyboard device.
